(19) United States
(12) Patent Application Publication
(10) Pub. No.: US 2011/0155138 A1
(43) Pub. Date: Jun. 30, 2011

(54) MASK

(76) Inventor: Jing-Jyr LIN, TaoyuanCounty (TW)

(21) Appl. No.: 12/977,847

(22) Filed: Dec. 23, 2010

(30) Foreign Application Priority Data
Dec. 24, 2009 (TW) 098224203

(51) Int. Cl. A62B 7/10

(52) U.S. Cl. 128/206.19

(57) ABSTRACT

A mask is revealed. The mask includes an upper construction surface and a lower construction surface, respectively disposed above and under a middle construction surface and having a main body that is arranged above and under a middle construction surface. The upper construction surface and/or the lower construction surface further include an extended part. The upper, lower and middle construction surfaces are folded to form a flat folded structure. In use, the upper and the lower construction surfaces are folded in opposite directions to form a 3D mask. The mask are formed of one construction surface or two construction surfaces or more construction surfaces. By the extended part, the mask is applied to users with various face shapes and sizes. Moreover, the air leakage is reduced and the filter efficiency is increased.

### BACKGROUND OF THE INVENTION

1. Fields of the Invention

The present invention relates to a mask.

2. Descriptions of Related Art

Generally, masks available now are divided into two types of masks-flat masks and half masks.

Masks can also be divided into two groups according to their applications—a group for filtering particulate matter and the other group for filtering gas. The rear one needs porous absorbent material to absorb various kinds of poisonous or organic gas. However, just like hamlets, the mask must be used correctly in order to have the best effects. While selecting the mask, users should not only pay attention to the filtration efficiency of the mask material, but also the fit of the mask to the face. Due to poor fit of the mask to the face, air together with harmful substances is inhaled trough a gap between the mask and the face.

As to the flat mask, refer to FIG. 1, it mainly includes a mask body 1′ and two bands 2′. The mask body 1′ is formed by a non-woven cloth 10′ and a nasal strip 11′. In use, the mask body 1′ is extended and an area around the nasal bridge is supported by the nasal strip 11′. Yet an area around a jaw is not supported by the strip or other devices so that gas leaks from this area.

The half mask mainly includes a cup body and two head bands. The shape of the half mask is close to the face's shape and the head band is used to fix the mask so that the fitness is increased. Yet while wearing the mask with such design, the head band presses the user's head and causes discomfort. Moreover, users will have breathing problems once the cup body covers user's face for a long time. Or the cup body with a certain height may distort or collapse while breathing forcefully. The mask is damaged easily.

In order to overcome the above shortcomings, refer to Taiwanese Pat. No. 1244399, a three-dimensional mask includes a middle surface supported by an upper surface and a lower surface. Although such three-dimensional mask provides more space for breathing, the mask still has disadvantages. The users' faces have different sizes so that the mask can't cover everyone's nose and jaw completely when the user's face is larger than normal size. Thus the mask can't fit closely to the face. There is a gap between the mask and the face so that bacteria and dust enter the mask through the gap and the filtering efficiency is reduced significantly.

There is a need to provide a three-dimensional mask with novel design that not only overcomes the gas leakage but also improves the filtering efficiency.

### SUMMARY OF THE INVENTION

Therefore it is a primary object of the present invention to provide a mask in which the cover area and the filter area of the mask are increased by an extended part of at least one main body. Thus users' face is covered completely and accurately by the mask and the mask fits snugly and securely. The air leakage is reduced and the filter efficiency is improved significantly.

It is another object of the present invention to provide a mask in which an upper construction surface, a middle construction surface, and a lower construction surface are folded to form a covered, flat folded structure so as to prevent an inner skin contact layer of the mask from becoming contaminated while putting on or taking off the mask.

It is a further object of the present invention to provide a mask that is formed by an upper construction surface, a middle construction surface, and a lower construction surface. While in use, the upper construction surface and the lower construction surface are folded toward the middle construction surface oppositely. Then the upper construction surface and the lower construction surface are extended to support the middle construction surface and form a 3D mask. Thus a space for breathing between the face and the mask is provided and the filter efficiency is improved. The mask can be applied to a highly polluted environment.

It is a further object of the present invention to provide a mask arranged with two bands. The shape of the bands can be linear, zonal or planar and the band can be ear-worn, head-worn or knot-connected type so as to relieve the sense of strain while wearing the mask.

In order to achieve above objects, a mask of the present invention includes an upper construction surface, a middle construction surface, and a lower construction surface. The upper construction surface is placed over the middle construction surface and the lower construction surface is positioned under the middle construction surface. The upper construction surface includes an upper main body that is disposed over the middle construction surface while the lower construction surface includes a lower main body that is set under the middle construction surface. Moreover, the upper construction surface and/or the lower construction surface further include an extended part. The upper construction surface, the middle construction surface, and the lower construction surface are folded to form a covered, flat folded structure. In use, the upper construction surface and the lower construction surface are folded in opposite directions and then are extended to support the middle construction surface and form a 3D mask.

Another mask of the present invention includes at least one main body and at least one expanded part. The expanded part is connected with the upper side and/or lower side of the main body. The least one main body further comprises an upper main body and a lower main body. The upper main body is connected with the lower main body.

By the design of the extended part, the mask is applied to users with various face shapes and sizes. Furthermore, the air leakage is reduced and the filter efficiency is improved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing a structure of a flat mask of a prior art;

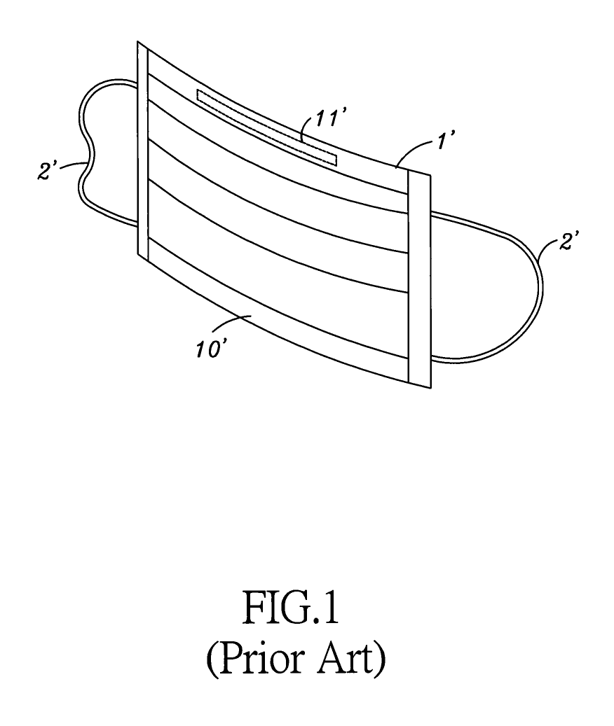

FIG. 2 is an extended view of an embodiment according to the present invention;

FIG. 3A is a schematic drawing showing a folded embodiment according to the present invention;

FIG. 3B is a cross sectional view along A-A line of the embodiment in FIG. 3A;

FIG. 4 is a schematic drawing showing wearing of an embodiment according to the present invention;

FIG. 5 is an extended view of another embodiment according to the present invention;

FIG. 6 is an extended view of another embodiment according to the present invention;

FIG. 7 is a schematic drawing of another embodiment according to the present invention; and

FIG. 8 is a schematic drawing of another embodiment according to the present invention.

### DETAILED DESCRIPTION OF THE PREFERRED EMBODIMENT

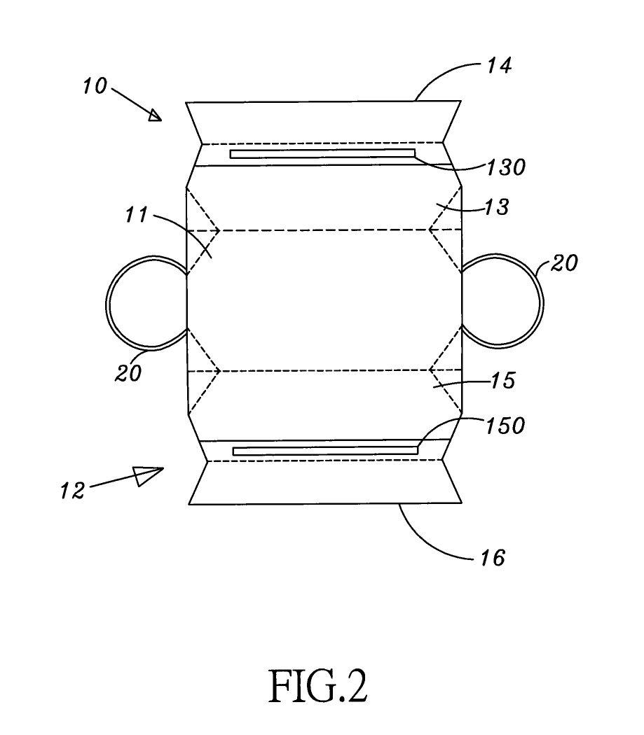

Refer to FIG. 2, a schematic drawing showing an embodiment of a mask according to the present invention is revealed. As shown in figure, a mask of the present invention includes an upper construction surface 10, a middle construction surface 11, and a lower construction surface 12. The upper construction surface 10 is disposed over the middle construction surface 11 and the middle construction surface 11 is arranged over the lower construction surface 12. That means the upper construction surface 10 and the lower construction surface 12 are over and under the middle construction surface 11 respectively. The upper construction surface 10, the middle construction surface 11 and the lower construction surface 12 respectively form an upper part, a middle part and the lower part of the mask. The upper construction surface 10 includes an upper main body 13 arranged over the middle construction surface 11. The lower construction surface 12 includes a lower main body 15 disposed under the middle construction surface 11. The middle construction surface 11 is made from fiber mixtures, compounds containing fibers, or compounds.

Moreover, the upper construction surface 10 and the lower construction surface 12 respectively further include an upper extended part 14 and a lower extended part 16. The upper extended part 14 is arranged on top of the upper main body 13 while the lower extended part 16 is set on bottom of the lower main body 15. This is a preferred embodiment but not intended to limit the present invention. The extended part can be only added onto the upper construction surface 10 or the lower construction surface 12. That means only the upper main body 13 or the lower main body 15 includes the extended part so as to increase the surface area of the mask and improve the fitness for reducing gas leakage and increasing filter efficiency significantly.

Furthermore, the upper main body 13, the middle construction surface 11, the lower main body 15 are integrated with one another and there is no need to sew or attach the upper main body 13 and the lower main body 15 respectively to the middle construction surface 11. Thus the manufacturing speed is improved, the material loss is reduced and the labor cost is down. In addition, the upper extended part 14 and the lower extended part 16 can be respectively integrated with the upper main body 13 and the lower main body 15. Thus the upper construction surface 10, the middle construction surface 11, and the lower construction surface 12 of the mask are integrated into one piece so as to increase production efficiency and reduce manufacturing cost. Yet the upper extended part 14 and the lower extended part 16 can be respectively connected to the upper main body 13 and the lower main body 15 by various ways such as adhesive bonding, sealing or sewing.

Still refer to FIG. 2, the present invention further includes a nasal strip 130 arranged at the upper construction surface 10 so as to fix the upper construction surface 10 on the bridge of the nose when a user wear the mask. The mask of the present invention further includes a chin strip 150 and two bands 20. The chin strip 150 is set on the lower construction surface 12 so that the lower construction surface 12 is fixed on the chin by the chin strip 150 while the user wearing the mask while the two bands 20 respectively are arranged at each of two sides of the mask and looped around users' ears so that the mask is hold securely to the user's face. In this embodiment, the two ends of the band 20 are both set on the middle construction surface 11. Yet the arrangement of the bands 20 is not limited to this way. One end of the band 20 is disposed on the upper construction surface 10 and the other end of the band 20 is arranged at the lower construction surface 12. The shape of the band 20 can be linear, zonal or planar. The band 20 can be ear-worn, head-worn or knot-connected type so as to improve wearing quality and varieties of the mask.

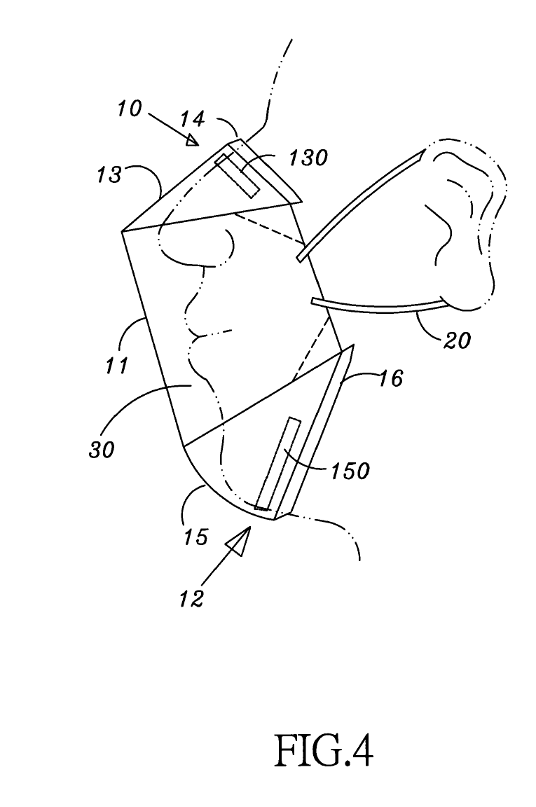

Besides, the two ends of the band 20 are connected with an interior or an exterior surface of the mask such as the interior or the exterior of the middle construction surface 11, wherein connecting the two ends of the band 20 with the exterior surface of the mask is the best performance shown as FIG. 4. When a user uses the mask, the band 20 lies between the mask and user's face and then makes the mask not able to stick to the user's face due to the two ends of the band 20 connected with the interior surface; therefore, the lack of the goodness of fit between the mask and user's face lets dirty air enter into a gap between the mask and user's face without being filtered. When the two ends of the band 20 are connected with the exterior surface of the mask, the mask worn by the user is able to stick to the user's face to increase the goodness of fit between the mask and the user's face and to prevent dirty air from entering through the gap. In addition, the two ends of the band 20 are connected with the exterior surface of the mask, so the two ends of the band 20 can press the exterior surface to make the mask effectively stick to the user's face when the user wears it. In this way, the benefit of filtering can be improved.

Otherwise, two ends of the band 20 is connected with the inner surface or the outer surface of the mask, such as the inner surface or the outer surface of the middle construction surface 11, wherein the preferred embodiment is the two ends of the band 20 is connected with the outer surface, as show in FIG. 4. Due to the two ends of the band 20 is connected with the inner surface, the two ends of the band 20 are located between the mask and the user's face while the user is wearing the mask. Therefore, the mask cannot be close to the user's face while a gap is disposed between the mask and the user's face. Hence, the adhesion between the mask and the user's face is reduced, it cannot prevent from the pollution air without filtration of the mask enter into the space between the mask and the user's face via the gap. The two ends of the band 20 is connected with the outer surface of the mask. The mask can be close to the user's face to increase the adhesion between the mask and the user's face. Therefore, it can prevent from pollution air enter into the space between the mask and the user's face via the gap. Besides, the two ends of the band 20 can press the outer surface of the mask during the use of the user while the two ends of the mask is connected with the outer surface of the mask. It induces the mask is more close to the user's face. Hence, the filtration of the mask is enhanced efficiently.

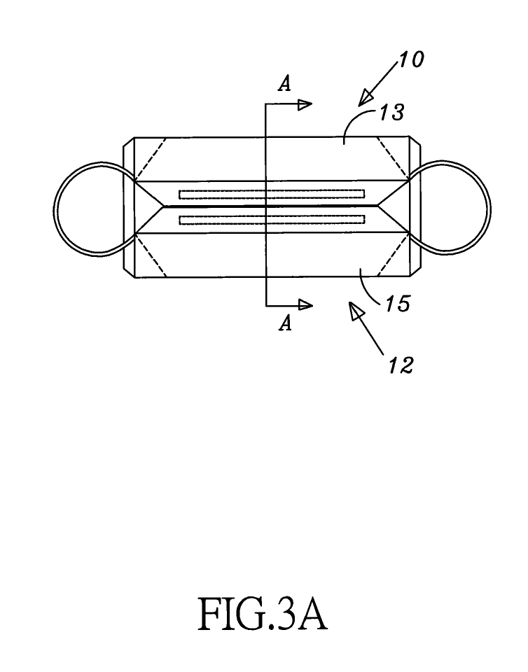

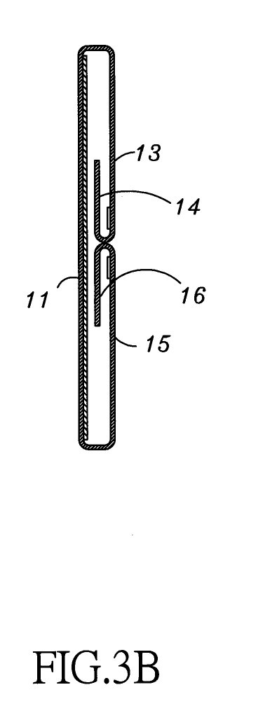

Refer to FIG. 3A and FIG. 3B, a schematic drawing of a folded mask and a cross section along A-A line in FIG. 3A are disclosed. Each of the two sides of the upper main body 13 and the lower main body 15 has a slope angle and so is each of the two sides of the upper extended part 14 and the lower extended part 16. Thus two sides of the upper main body 13, the lower main body 15, the upper extended part 14 and the lower extended part 16 are sloped and shaped like a pyramid. The upper construction surface 10 and the lower construction surface 12 are folded into the middle construction surface 11 in opposite directions so as to form a covered, flat folded structure that covers an inner skin contact layer of the mask. Thus the inner skin contact layer will not get contaminated while applying or removing the mask. Refer to FIG. 2, the mask is folded along the dotted lines.

In addition, the upper extended part 14 and the lower extended part 16 are respectively folded into an inner side of the upper main body 13 and the lower main body 15. The preferred width of the upper main body 13 as well as the width of the lower main body 15 is a half of the width of the middle construction surface 11. As to the optimal width of the upper extended part 14 and the width of the lower extended part 16 are respectively a half of the width of the upper main body 13 and the width of the lower main body 15.

Refer to FIG. 4, a schematic drawing showing the wearing of the mask is revealed. As shown in figure, the upper construction surface 10, the middle construction surface 11 and the lower construction surface 12 are integrated and folded toward the middle construction surface 11 so as to form a covered, flat folded structure. In use, the upper construction surface 10 and the lower construction surface 12 are firstly folded inward toward the middle construction surface 11 and then are extended so as to support the middle construction surface 11 and form a 3D mask. Furthermore, while wearing the 3D mask of the present invention, users can extend the upper extended part 14 and/or the lower extended part 16 so as to cover the nasal bridge and the chin completely. Thus the mask is firmly held in place even the user's face is larger than most other people. As a result, the air leakage is reduced, the filtering area of the mask is increased and the filtering efficiency is improved. In addition, by the upper extended part 14 and/or the lower extended part 16, the mask will not be misplaced or displaced when the user's face moves or turns sideways.

Still refer to FIG. 4, the nasal strip 130 on the upper construction surface 10 is attached to two sides of the nasal bridge closely so that the contact area between the nasal bridge and the middle construction surface 11 is increased. As to the middle construction surface 11 on the lower construction surface 12, it is placed on two sides of the chin. Thus the contact area between the chin and the lower construction surface 12 is increased. By the polygonal design, a close space 30 is generated while the middle construction surface 11 being extended. Thus the distance between the middle construction surface 11 and the face is increased. As a result, the air flow area and the filter efficiency are increased while the user breathing in/out and the breathing is more free and easy.

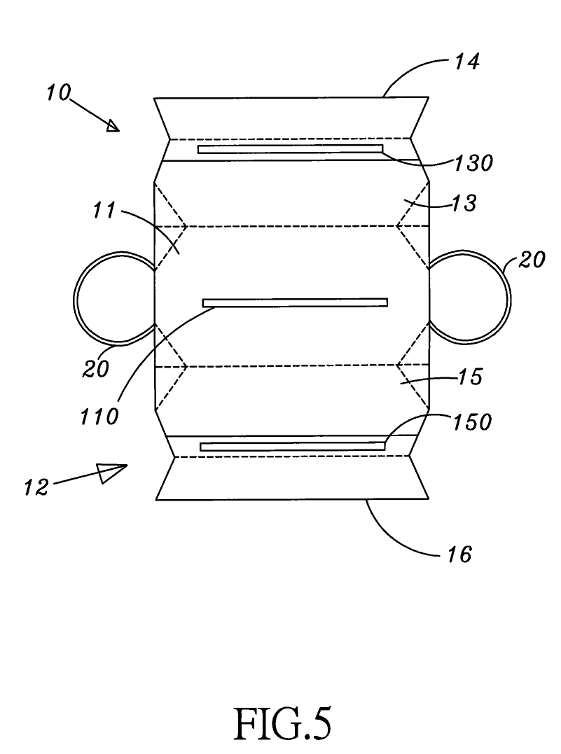

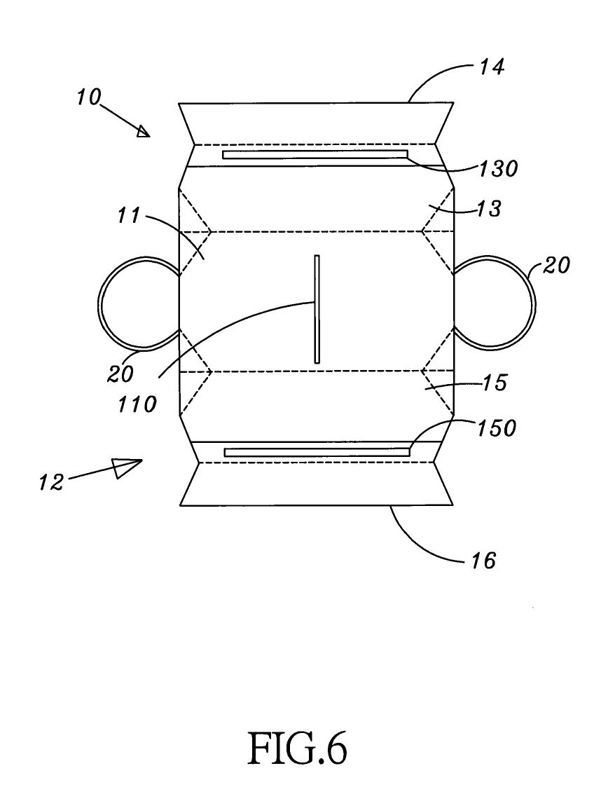

Refer to FIG. 5 and FIG. 6, another embodiment is revealed. As shown in figure, due to different applications, the mask is made from various materials. The thickness and weight of the mask will vary according to requirements of filtering material.

A middle strip 110 is set on the middle construction surface 11. In this embodiment, the middle strip 110 is arranged at the outer surface of the middle construction surface 11 horizontally or vertically so as to support the weight of the shown in the figure, shown in the FIG. 5 and FIG. 6. Thus the middle construction surface 11 can still maintain the shape without sagging even the filter material is thick and heavy. Moreover, the shape of the middle construction surface 11 can be modified according to user's needs.

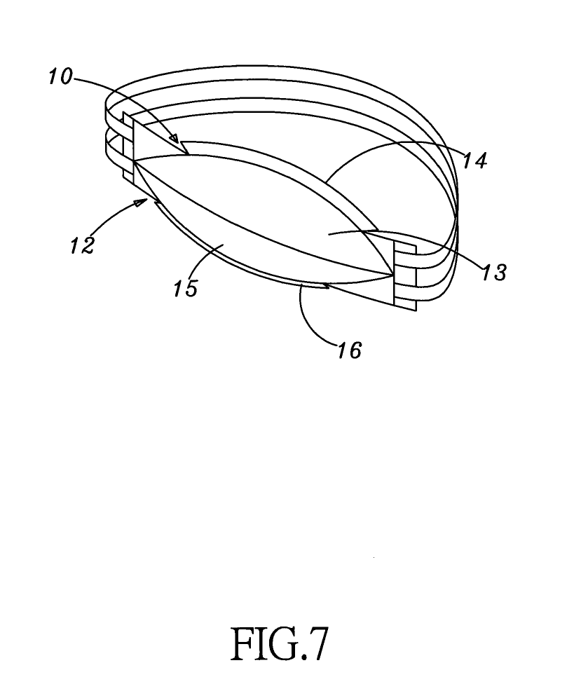

Refer to FIG. 7, another embodiment is revealed. As The prior embodiment discloses that the mask includes three construction surfaces comprising the upper construction surface 10, middle construction surface 11, and lower construction surface 12. But this embodiment is different from the prior embodiment, the mask of this embodiment includes two construction surfaces comprising a upper construction surface 10 and a lower construction surface 12 connected with each other. As shown in this embodiment, the upper construction surface 10 of this embodiment includes an upper main body 13 and an upper expanded part 14. The lower construction surface 12 includes a lower main body 15 and a lower expanded part 16. One side of the upper main body 13 is connected with one side of the lower main body 15. The upper expanded part 14 is connected with other side of the upper main body 13. The lower expanded part 16 is connected with other side of the lower main body 15.

In use the mask of this embodiment, the upper main body 13 and the lower main body 15 are expanded respectively for covering the user's face. Then, the upper expanded part 14 and the lower expanded part 16 are expanded toward outside of the mask for increasing the worn area of the mask to cover the user's face. The expanded mask can be covered onto and close to the user's face for increasing the adhesion between the expanded mask and the user's face to reduce the leakage ratio. It further enhances the filtration efficiency of the mask.

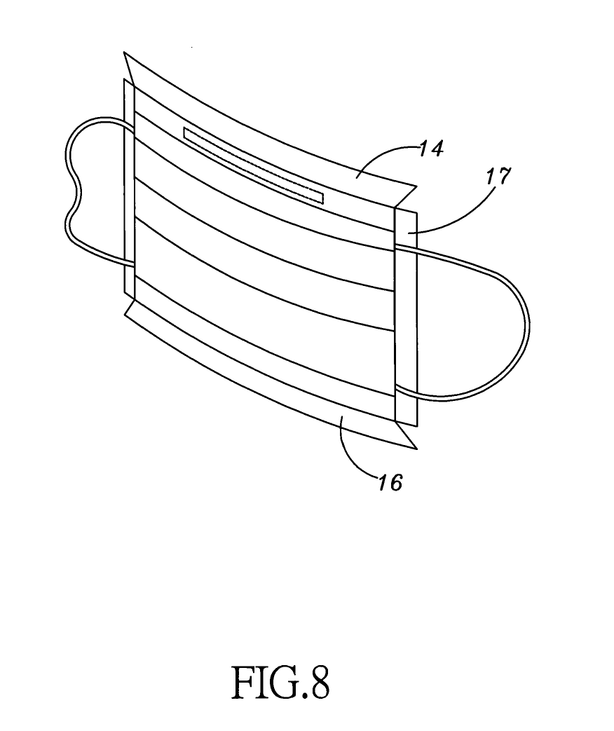

The mask of this embodiment includes two expanded parts, however, the invention is not limited to the mask including the two expanded parts. It also can be that only one expanded part is selectively set onto the mask, such that the mask includes the upper expanded part 14 or the lower expanded part 16 alternatively. Here is no more description about the relationship of the upper expanded part 14 or the lower expanded part 16, again. The above description of the mask is formed of the two construction surfaces, but the mask also can be formed of only one construction surface or more construction surfaces (such as four construction surfaces) referring to follow detailed description. Refer to FIG. 8, another embodiment is revealed. As show in figure, the mask of this embodiment includes a main body 17, an upper expanded part 14 and a lower expanded part 16. The upper expanded part 14 is connected with the upper side of the main body 17, and the lower expanded part 16 is connected with the main body 17. A construction surface is formed of the main body 17, the upper expanded part 14 and the lower expanded part 16. Further, this embodiment also can be that the mask includes only one expanded part, and here is no more description about the relationship of the mask including only on expanded part. Furthermore, the nasal strip 130, the chin strip 150 and the band 20 of the FIG. 2 can be applied to the embodiment of the FIG. 7 and FIG. 8, and here is no more description about the relationship of the nasal strip 130, the chin strip 150 and the band 20 regarding the applications in the FIG. 7 and FIG. 8.

In summary, the present invention provides a mask that includes the upper construction surface, the middle construction surface, and the lower construction surface. The upper construction surface is arranged over the middle construction surface and the lower construction surface is positioned under the middle construction surface. The upper main body of the upper construction surface is disposed over the middle construction surface while the lower main body of the lower construction surface is set under the middle construction surface. Moreover, the upper construction surface and/or the lower construction surface further include an extended part so as to increase the cover area and the filter area of the mask. The upper construction surface, the middle construction surface and the lower construction surface are folded to form a covered, flat folded structure. In use, the upper construction surface and the lower construction surface are folded inward firstly and then are extended so as to support the middle construction surface and form a 3D mask. By the design of the extended part, the mask is applied to users with various face shapes and sizes. Furthermore, the air leakage is reduced and the filter efficiency is improved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A mask comprising:
a middle construction surface that is located on a middle part of the mask;
an upper construction surface that is arranged at an upper part of the mask, disposed over the middle construction surface and having an upper main body while the upper main body is disposed over the middle construction surface; and
a lower construction surface that is disposed on a lower part of the mask, arranged under the middle construction surface, and having a lower main body while the lower main body is disposed under the middle construction surface;
wherein the upper construction surface and/or the lower construction surface further includes an extended part connected to the upper main body and/or the lower main body while the upper construction surface, the middle construction surface and the lower construction surface are folded to form a covered, flat folded structure; the upper construction surface and the lower construction surface are folded inward firstly in use and then are extended to support the middle construction surface so as to form a three-dimensional mask.

2. The device as claimed in claim 1, wherein the extension part of the upper construction surface is arranged over the upper main body.

3. The device as claimed in claim 1, wherein the extension part of the lower construction surface is disposed under the lower main body.

4. The device as claimed in claim 1, wherein the middle construction surface is made from fiber mixtures, compounds containing fibers, or compounds.

5. The device as claimed in claim 1, wherein a width of the upper main body as well as a width of the lower main body is equal to a half of a width of the middle construction surface.

6. The device as claimed in claim 1, wherein a width of the extended part of the upper construction surface and a width of the extended part of the lower construction surface are respectively a half of a width of the upper main body and a width of the lower main body.

7. The device as claimed in claim 1, wherein each of two sides of the upper main body and each of two sides of the lower main body have a slope angle.

8. The device as claimed in claim 1, wherein a close space is provided when the middle construction surface is extended.

9. The device as claimed in claim 1, wherein each of two sides of the extended part has a slope angle.

10. The device as claimed in claim 1, wherein the upper main body, the middle construction surface and the lower main body are integrated.

11. The device as claimed in claim 1, wherein the upper main body and the extended part are integrated.

12. The device as claimed in claim 1, wherein the lower main body and the extended part are integrated.

13. The device as claimed in claim 1, wherein the mask further includes two bands arranged at each of two sides thereof respectively.

14. The device as claimed in claim 13, wherein the band is a linear, zonal or planar band.

15. The device as claimed in claim 1, further comprising:
a middle strip disposed on the middle construction surface.

16. The device as claimed in claim 15, wherein the middle strip is disposed on the middle construction surface horizontally or vertically.

17. The device as claimed in claim 1, comprising:
a band whose two ends are connected with an exterior surface of the mask.

18. A mask, comprising:
at least one main body; and
at least one expanded part, connected with the upper side and/or the lower side of the main body.

19. The device as claimed in claim 18, wherein the main body comprises an upper main body and a lower main body connected with each other, and the expanded part is connected with the upper body and/or the lower body.

20. The device as claimed in claim 18, further comprising:
a band whose two ends are connected with an exterior surface of the mask.
